(19) United States
(12) Patent Application Publication
(10) Pub. No.: US 2002/0054787 A1
(43) Pub. Date: May 9, 2002

(54) Device for the face end coupling of profile bars

(76) Inventor: Helmut Kahl, Westfalica (DE)

Correspondence Address: BROWDY AND NEIMARK, P.L.L.C, 624 Ninth Street, N.W., Washington, DC, 20001, US

(21) Appl. No.: 09/809,432

(22) Filed: Mar. 16, 2001

(30) Foreign Application Priority Data
Mar. 16, 2000 (DE) 100 12 129 0 12

(51) Int. Cl. F16B 1/00

(52) U.S. Cl. 403/403

(57) ABSTRACT

A device for the face end coupling of profile bars that are provided with undercut, continuous longitudinal grooves and incorporate a central core that forms the base of the longitudinal grooves and, projecting from same, webs that encompass the longitudinal grooves and have angled web shoulders, having a fastening member that is fixable with a shaft section at the face end in the core of a first profile bar in such a way that a head of the fastening member extends into a longitudinal groove of a second profile bar that is to be connected crosswise, characterized in that a fastening surface of the fastening member facing the shaft section or face end of the first profile bar has a distance to inside surfaces of web shoulders that encompass the longitudinal grooves, and that a wedge-shaped locking element can be brought into close-lying engagement with a tensioning surface against the fastening surface on one hand, and with a support surface against the inside surfaces of the web shoulders on the other hand, and is displaceable in the longitudinal direction of the longitudinal groove so that the profile bars can be firmly locked to one another.

The present invention relates to a device for the face end coupling of profile bars that are provided with undercut, continuous longitudinal grooves and incorporate a central core that forms the base of the longitudinal grooves, and, projecting from this core, webs that encompass the longitudinal grooves and have angled web shoulders, having a fastening member that is fixable with a shaft section at the face end in the core of a first profile bar in such a way that a head of the fastening member extends into a longitudinal groove of a second profile bar that is to be connected crosswise.

A coupling device of this type is known, for example, from DE 34 38 773, which relates to a cross coupling of profile bars.

It is the object of the invention to improve a device according to the preamble for connecting profile bars in such a way that a face end connection that can absorb large forces and can be installed in the simplest possible manner is created with the fewest possible number of simple to manufacture components.

This object is met with a device for the face end coupling of profile bars that are provided with undercut, continuous longitudinal grooves and incorporate a central core that forms the base of the longitudinal grooves, and, projecting from this core, webs that encompass the longitudinal grooves and have angled web shoulders, having a fastening member that is fixable with a shaft section at the face end in the core of a first profile bar in such a way that a head of the fastening member extends into a longitudinal groove of a second profile bar that is to be connected crosswise, with the inventive device characterized in that a fastening surface of the fastening member facing the shaft section or face end of the first profile bar has a distance to inside surfaces of the web shoulders that encompass the longitudinal grooves, and that a wedge-shaped locking element can be brought into close-lying engagement with a locking surface against the fastening surface on one hand and with a support surface against the inside surfaces of the web shoulders on the other hand and is displaceable in the longitudinal direction of the longitudinal groove so that the profile bars can be firmly locked to one another.

The fastening member is advantageously a head screw, the threaded shaft section of which can be screwed into the core of the first profile bar.

An underside of the head that faces the shaft section advantageously forms the fastening surface.

Provision is preferably made for the fastening member or head screw to incorporate, adjacent to the head, a threadless collar section that serves as a catch or screw-in limit stop and determines, with its axial length, the distance between the fastening surface and the inside surfaces of the web shoulders.

The locking element may comprise a central elongated cutout to receive the shaft section or collar section of the fastening member. The width of this cutout advantageously corresponds to the respective diameter or thickness of the collar section. Provision is preferably made for the collar section to be cylindrical. It may incorporate two opposing flattened areas, the mutual distance of which corresponds to the width of the cutout.

In a preferred embodiment, provision is made for the locking element to incorporate a straight section with a constant thickness followed by a wedge section incorporating a wedge surface.

The wedge surface may be flat and extend at a fixed angle to the support surface. Alternatively, the wedge surface may be curved concavely or convexely.

In a particularly advantageous embodiment, the locking element has a shoulder to secure the profile bars against twisting, which engages in a form-fitting manner into opening slits of the longitudinal grooves of the first and second profile bar that are delimited by the web shoulders, said longitudinal grooves being located in one plane. The locking element may incorporate two shoulders of this type.

The shoulder is advantageously designed to cooperate with an assembly tool.

The axial length of the collar section of the fastening member on one hand and the dimensions of the wedge-shaped section of the locking element on the other hand are preferably matched to one another such that the locking element in its fastening displacement does not project beyond the profile contour of the first profile bar.

Provision may be made for the width of the cutout of the locking element, the diameter of the collar section, and the distance of the flattened areas on both sides and the width of the opening slit of the longitudinal grooves, respectively, to correspond to one another to attain a good protection against twisting.

Alternatively, provision may be made for the collar section to have a centering sleeve placed upon it, the outside diameter of which corresponds to the width of the cutout of the locking element and to the width of the opening slit of the longitudinal grooves.

The invention will be explained below based on an embodiment, with reference made to a drawing, in which:

FIG. 1 shows a perspective schematic illustration of a cross-coupling of two profile bars using the inventive device;

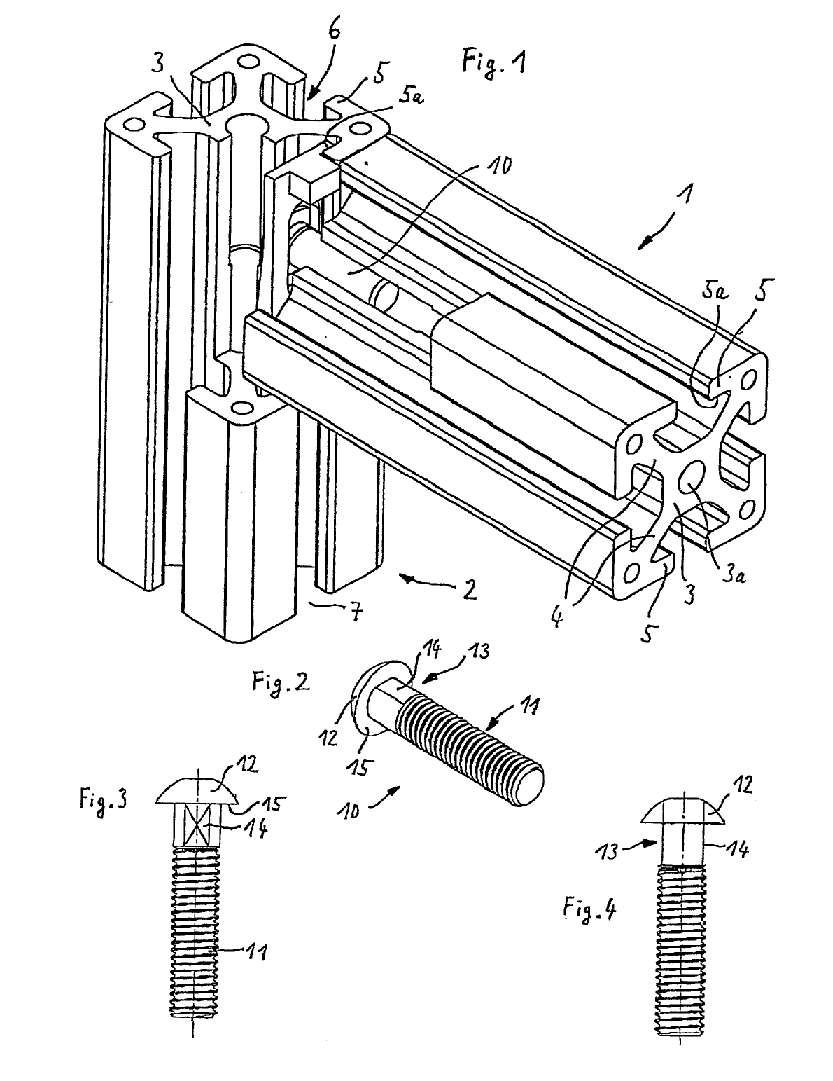

FIG. 2 shows a perspective view of a fastening member;

FIG. 3 shows a top view of the fastening member;

FIG. 4 shows a side view of the fastening member;

FIG. 5 shows a perspective view of a locking element;

FIG. 6 shows a top view of the locking element; and

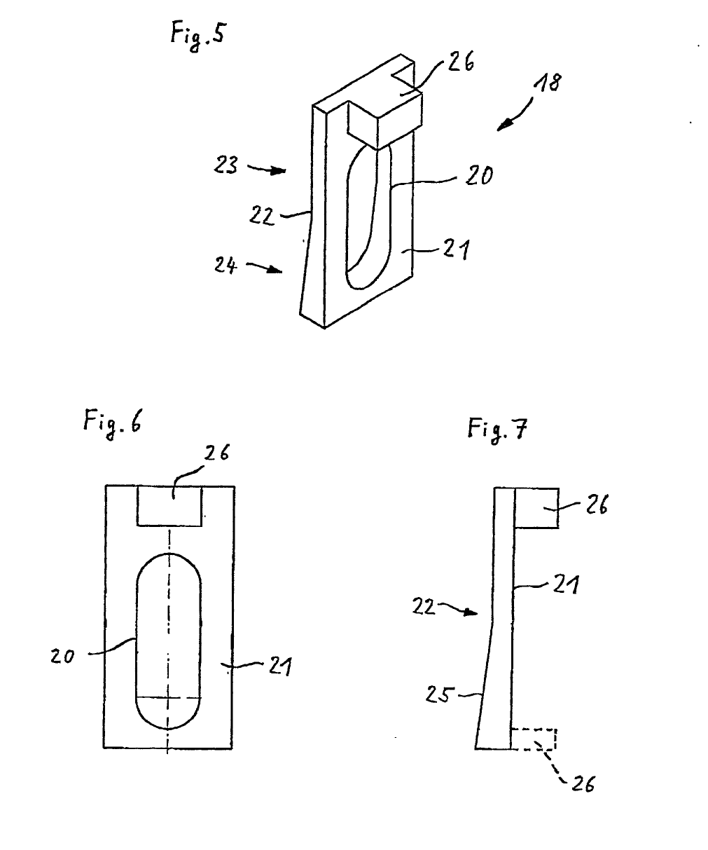

FIG. 7 shows a side view of the locking element.

FIG. 1 shows a perspective view of a cross coupling of two profile bars that consist of light metal, with a first profile bar 1 fastened at its face end to a profile bar 2 extending crosswise to the former.

Both profile bars 1, 2 are identical to one another in this example and incorporate a core 3 and, radially projecting from the same, webs 4, from which angled web shoulders 5 project. The given core 3 forms the bottom of longitudinal grooves 6 and they are encompassed by the webs and web shoulders in an undercut-like manner. Web shoulders 5, which are disposed opposite one another in pairs, delimit opening slits 7 and have inside surfaces 5a.

As FIG. 1 furthermore shows, a fastening member 10, in the present case a head screw (FIG. 2 through 4) is screwed with its threaded shaft section 11 into a central through-opening 3a of the core 3 of the first profile bar 1.

The head screw 10 has, as shown in FIG. 2 through 4, between its nearly semicircular head 12 and the shaft section 11, a collar section 13, which is cylindrical in the present embodiment and has a certain axial length as well as two opposing lateral flattened areas 14, with the mutual distance between the flattened areas being less than the outside diameter of the threaded or shaft section 11 and the diameter of the remaining cylindrical area of the collar section 13 being nearly identical to the outside diameter of the shaft section 11.

The threadless collar section 13 thus forms a screw-in limit stop for the head screw 10. The underside 15 of the head screw 10, which forms a fastening surface, thus has, in the completely screwed-in condition of the head screw 10, a distance from the face end of the first profile bar 1 facing the second profile bar 2 that corresponds to the axial length of the collar section 13. Since this dimension is selected larger than the thickness of the web shoulders 5 (of the second profile bar 2), a distance exists between the fastening surface 15 and the inside surfaces 5a of the web shoulders 5 of the second profile bar 2, so that a substantially wedge-shaped locking element 18 is receivable between the head 12 and the adjacent web shoulders 5 of the second profile bar.

FIG. 5 shows a complete perspective view of the locking element 18 from the same viewing direction as FIG. 1, and it can thus be seen from FIG. 1 that the head screw 10 penetrates with its collar section 13 through a central, elongated cutout 20 of the locking element 18 and hooks behind the same with its head 12 or fastening surface 15.

As FIG. 5 through 7 furthermore show, the locking element 18 incorporates a flat support surface 21 with which, or with the lateral edges of which, the locking element sits against the inside surfaces 5 a of the web shoulders 5, and also a fastening area 22 that first extends along a straight section 23 of constant thickness of the locking element parallel to the support surface 21 and then transitions, in a wedge section 24, into a wedge surface 25 extending at an angle to the support surface 21.

The locking element 18 further has, on an end section opposite the wedge section 24 (or on both end sections, as indicated in FIG. 7) a block-shaped shoulder 26, the width of which corresponds to the width or to the clear width of the opening slits 7 of the profile bars, so that the shoulder, as shown by FIG. 1, engages in a form-fitting manner in the corner area of the connection into two opening slits 7 extending in one plane and thus forms a protection against a twisting of the profile bar coupling. An improved effect of the protection against twisting results if the locking elements 18 has two such shoulders 26 (indicated in FIG. 7 by a dashed line).

An additional centering effect and protection against twisting may be attained with a sleeve placed upon the collar section 13, with the outer diameter of said sleeve corresponding to the width of the cutout 20 and the opening slit 7.

The shoulder 26 that is visible in FIG. 1 may simultaneously serve as a point of application for an assembly tool.

A face end coupling of two profile bars according to FIG. 1 is produced with the inventive device as follows. First the fastening member or head screw 10, is inserted through the cutout 20 of the locking element 18 and both parts are subsequently fastened to the first profile bar I by screwing the head screw 10 into the core 3. Depending on the specific application the head screw IO may have a self-cutting thread.

The head screw 10 is screwed in far enough so that the loosely held locking element 18 can, in a position in which the straight section 23 is located in the area of the head 12, easily be inserted into the longitudinal groove 6 and the profile bar I slides along on the opposite (outer) side of the longitudinal groove 6 on the corresponding side face of the first profile bar 1.

To facilitate this screw-in process, the collar section 13 is provided, as described above, which forms a catch or screw-in limit stop.

After the first profile bar 1 has been brought into a desired position on the second profile bar in this manner, a solid connection is created by moving the locking element 18 into the area of the head 12 with the wedge section 24 by a displacement in the longitudinal direction of the longitudinal groove 6, so that the fastening surface 15 of the head 12 is increasingly supported on the wedge surface 25 or its lateral edges. This is done, for example, by applying a lever-type tool to the shoulder 26.

### List of Reference Numerals

1 first profile bar

2 second profile bar

3 core

3a through-opening

4 web

5 web shoulder

5a inside surface

6 longitudinal groove

7 opening slit

10 fastening member (head screw)

11 shaft section

12 head

13 collar section

14 flattened area

15 fastening surface

18 locking element

20 cutout

21 support surface

22 locking surface

23 straight section

24 wedge section

25 wedge surface

26 shoulder

What is claimed is:

1. A device for the face end coupling of profile bars (1, 2) that are provided with undercut, continuous longitudinal grooves (6) and incorporate a central core (3) that forms the base of the longitudinal grooves (6) and, projecting from this core, webs (4) that encompass the longitudinal grooves and have angled web shoulders (5), having a fastening member (10) that is fixable with a shaft section (11) at the face end in the core (3) of a first profile bar (1) in such a way that a head (12) of the fastening member (10) extends into a longitudinal groove (6) of a second profile bar (2) that is to be connected crosswise, characterized in that a fastening surface (15) of the fastening member (10) facing the shaft section (11) or face end of the first profile bar (1) has a distance to inside surfaces (5a) of web shoulders (5) that encompass the longitudinal grooves (6) and that a wedge-shaped locking element (18) can be brought into close-lying engagement with a tensioning surface (22) against the fastening surface (15) on one hand, and with a support surface (21) against the inside surfaces (5a) of the web shoulders (5) on the other hand, and is displaceable in the longitudinal direction of the longitudinal groove (6) so that the profile bars (1, 2) can be firmly locked to one another.

2. A device according to claim 1, characterized in that the fastening member is a head screw (10), the threaded shaft section (11) of which is screwable into the core (3) of the first profile bar (1).

3. A device according to claim 1 or 2, characterized in that an underside of the head (12) that faces the shaft section (11) forms the fastening surface (15).

4. A device according to any of the above claims, characterized in that the fastening member (10) has, adjacent to the head (12) a threadless collar section (13) that serves as a screw-in limit stop and determines with its axial length the distance between the fastening surface (15) and the inside surface (5) of the web shoulders (5).

5. A device according to any of the above claims, characterized in that the locking element (18) incorporates a central elongated cutout (20) for receiving the shaft or collar section (11, 13) of the fastening member (10).

6. A device according to claim 5, characterized in that the width of the cutout (20) corresponds to the diameter or thickness of the collar section (13).

7. A device according to any of claims 4 through 6, characterized in that the collar section is cylindrical.

8. A device according to any of claims 4 through 7, characterized in that the collar section (13) incorporates two opposing flattened areas (14), the mutual distance of which corresponds to the width of the cutout (20).

9. A device according to any of the above claims, characterized in that the locking element (18) incorporates a straight section (23) of a constant thickness, which is followed by a wedge section (24) that incorporates a wedge surface (25).

10. A device according to claim 9, characterized in that the wedge surface (25) is flat and extends at a fixed angle to the support surface (21).

11. A device according to any of claims I through 9, characterized in that the wedge surface (25) is curved concavely or convexely.

12. A device according to any of the above claims, characterized in that the locking element (18) incorporates a shoulder (26) to protect against a twisting of the profile bars (1, 2) that hooks, in a form-fitting manner, into opening slits (7) of the longitudinal grooves (6) of the first and second profile bar (1, 2) that are delimited by the web shoulders (5a), said longitudinal grooves being located in one plane.

13. A device according to claim 12, characterized in that the locking element (18) incorporates two shoulders (26) (FIG. 7).

14. A device according to any of the above claims, characterized in that the shoulder 26 is designed to cooperate with an assembly tool.

15. A device according to any of claims 4 through 14, characterized in that the axial length of the collar section (13) of the fastening member (10) on one hand and the dimensions of the wedge section (24) of the locking element (18) on the other hand are matched to one another in such a way that the locking element after its locking displacement does not project beyond the profile contour of the first profile bar (1) (FIG. 1).

16. A device according to any of claims 4 through 15, characterized in that the width of the cutout (20) of the locking element (18), the diameter of the collar section (13) and the distance of the flattened areas (14) on both sides, and the width of the opening slit (7) of the longitudinal groove (6) conform to one another to attain a good protection against twisting.

17. A device according to any of claims 4 though 15, characterized in that a centering sleeve is placed upon the collar section (13), the outside diameter of which corresponds to the width of the cutout (20) of the locking element (18) and to the width of the opening slit (7) of the longitudinal grooves (6).
